(19) United States
(12) Patent Application Publication
(10) Pub. No.: US 2008/0270074 A1
(43) Pub. Date: Oct. 30, 2008

(54) User customized machine data acquisition system

(75) Inventors: Robert A. Horkavi, Dunlap, IL (US); Donna K. Laube, Peoria, IL (US); Stuart C. Johnson, Peoria, IL (US); William T. Hasty, Manito, IL (US); Paul A. Ring, Dunlap, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/797,013

(22) Filed: Apr. 30, 2007

(51) Int. Cl. G06F 11/30

(52) U.S. Cl. 702/182

(57) ABSTRACT

A data acquisition system for a machine is disclosed. The data acquisition system has at least one sensor disposed on a machine and configured to produce a signal indicative of a value of an operational condition of the machine. The system also has a controller communicatively coupled to the at least one sensor. The controller is configured to receive a user-defined event associated with operation of the machine, and receive a user-defined trigger corresponding to the event. The controller is also configured to receive a user-defined parameter to be reported upon triggering of the event, and report an occurrence of the event and a value of the user-defined parameter based on the signal.

### TECHNICAL FIELD

The present disclosure relates generally to a flexible machine data acquisition system, and more particularly, to a data logging system allowing user customization.

### BACKGROUND

Machines such as, for example, passenger vehicles, trains, marine vessels, construction equipment, excavating machines, assembly line production equipment, etc., are often equipped with sensors for measuring operational conditions of the machine. These operating conditions may include, for example, engine RPM, oil pressure, water temperature, boost pressure, oil contamination, electric motor current, hydraulic pressure, system voltage, fuel consumption, payload, ground speed, transmission ratio, cycle time, and other parameters indicative of machine health, status, or performance. Storage devices may be provided on the machine to compile an operating condition database or log for later evaluation of machine performance.

During operation, it may be beneficial to monitor the sensed operating conditions of a machine to diagnose and/or analyze its performance. As such, systems have been provided to monitor machine operating conditions and log faults, report events, and/or provide alerts in response to the monitored conditions. In some instances, the faults, events, and/or alerts may be communicated to an off-board system responsible for tracking the operations of one or more machines (e.g., a fleet). For example, in response to oil pressure falling below a predetermined value and/or surpassing a predetermined contamination threshold, an oil change alert may be stored in a machine maintenance log, reported to the machine operator, and/or communicated to an off-board system. However, not all such events may warrant immediate alerts and/or action. As such, there is a need to filter the alerts based on user preferences.

One machine health monitoring and recording system that filters alerts based on user preferences is described in U.S. Patent Application Publication No. 2004/0158367 (the '367 publication) by Basu et al., published on Aug. 12, 2004. The '367 publication describes a system that monitors operation of a vehicle and triggers alerts in response to the occurrence of events. The system allows a user to customize preferences as to the manner in which the system alerts the user. For example, an alerting preference may include the number of times an event must occur before the system alerts the user. When an event or sequence of events satisfies the alerting preference, the system reports predetermined data corresponding to the detected event.

Although the machine monitoring system of the '367 publication may reduce the time and resources spent dealing with marginal or low level alerts, the reports only include default data associated with the event. As a result, the reports may be insufficient to diagnose problems, trend machine and/or operator performance, and/or perform machine maintenance or repair. Therefore, there is a need for more dynamic reporting of machine events and adequate representation of machine operating conditions associated with the events for diagnostic purposes.

The disclosed system is directed to overcoming one or more of the problems set forth above.

### SUMMARY OF THE INVENTION

One aspect of the disclosure is directed to a data acquisition system for a machine. The data acquisition system may include at least one sensor disposed on a machine and configured to produce a signal indicative of a value of an operational condition of the machine. The system may also include a controller communicatively coupled to the at least one sensor. The controller may be configured to receive a user-defined event associated with operation of the machine, and receive a user-defined trigger corresponding to the event. The controller may also be configured to receive a user-defined parameter to be reported upon triggering of the event, and report an occurrence of the event and a value of the user-defined parameter based on the signal.

Another aspect of the disclosure is directed to a method of acquiring data for a machine. The method may include sensing a value of at least one operational condition of the machine. The method may also include receiving a user-defined event associated with operation of the machine, and receiving a user-defined trigger corresponding to the event. The method may also include receiving a user-defined parameter to be reported upon triggering of the event, and reporting an occurrence of the event and a value of the user-defined parameter based on the signal.

### BRIEF DESCRIPTION OF THE DRAWINGS

FIG. 1 is a schematic representation of an exemplary disclosed data acquisition system.

FIG. 2 is a pictorial representation of an exemplary disclosed user interface for use with the data acquisition system of FIG. 1.

### DETAILED DESCRIPTION

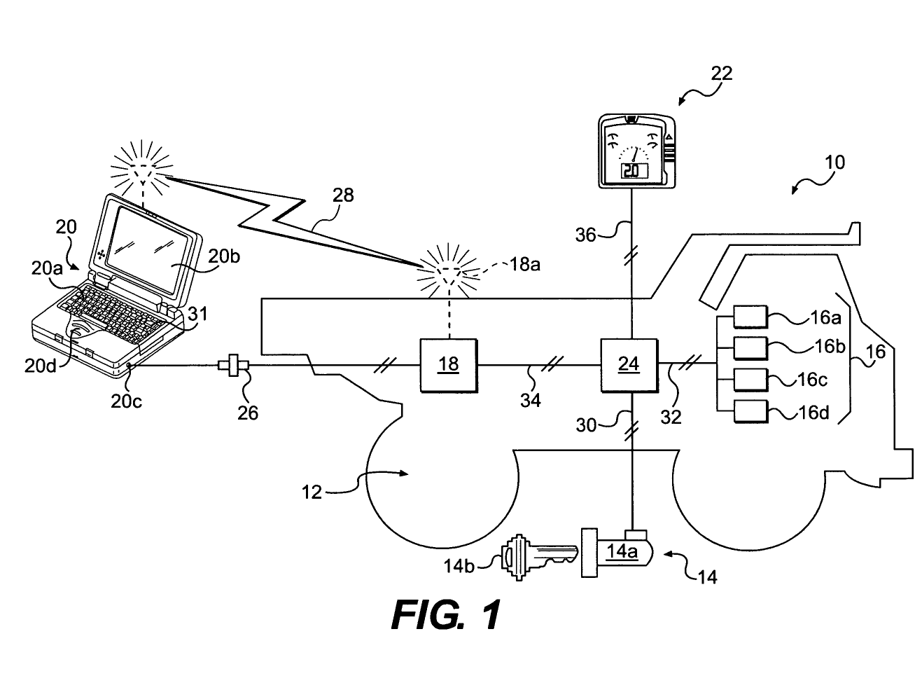

FIG. 1 shows a machine 10 having an exemplary data acquisition system 12. Machine 10 may be a fixed or mobile machine that performs some type of operation associated with an industry such as mining, construction, farming, transportation, or another known industry. For example, machine 10 may be an earth moving machine, a generator set, a pump, a passenger vehicle, a marine vessel, or any other suitable operation-performing machine. Data acquisition system may include an identification module 14, an interface module 16, a communication module 18 configured to communicate with an off-board system 20, and an operator interface 22 communicatively connected to a controller 24. It is contemplated that one or more of identification module 14, interface module 16, communication modules 20, and controller 24 may be integrated as a single unit, if desired.

Identification module 14 may include any means for receiving an operator identification code and generating a signal indicative of the code for purposes of identifying the operator controlling machine 10. Such means may include, for example, a switch 14a configured to receive, sense, and/or detect a coded key 14b having magnetic information thereon, a memory chip embedded thereon, an electromagnetic identification circuit included thereon, a keypad allowing the code to be manually entered by an operator, a data port allowing direct communication with a service tool or a computer having the code, an antenna allowing reception of the code from a remote location, a scanner configured to read coded indicia, or any other configuration that can receive the code and generate a signal indicative of the code. For example, key 14b may be a radio-frequency identification (RFID) chip having an operator code, and switch 14a may be a radio-frequency sensor configured to sense and read the operator code within a certain proximity. A code, for the purposes of the present disclosure, may include a configuration of letters, numbers, symbols, pulses, voltage levels, indicia, signals, magnetic fields, sound or light waves, and other configurations that represent an assigned meaning. The code may take the form of one or more of human readable information and machine readable information. It is contemplated that identification module 14 may receive additional pieces of coded information other than an operator identification code.

Interface module 16 may include a plurality of sensors 16a-d distributed throughout the machine to gather data from various components and subsystems of machine 10. It is contemplated that a greater or lesser number of sensors may be included than shown in FIG. 1. Sensors 16a-d may be associated with and/or monitor a power source, a transmission, a traction device, a work tool, an exhaust system, a suspension system, and/or other components and subsystems of machine 10. These sensors may measure and/or detect operational parameter values based on the gathered data, such as, for example, engine RPM, ground speed, track/wheel slip, oil pressure, water temperature, boost pressure, oil contamination, exhaust temperature, NOx level, urea level, electric motor current, hydraulic pressure, system voltage, fuel consumption, payload weight, ground speed, distance traveled, transmission ratio, cycle time, start time, stop time, grade, a global position of machine 10, brake temperature, and other such parameters of interest. The sensors 16a-d may each generate a signal corresponding to a value of the respective measured parameter (e.g., 170° F., 1.5 atm, 1,200 RPM, etc.) Other pieces of information may be generated or maintained by the interface module such as, for example, time of day and date.

Communication module 18 may include any device configured to facilitate communications between controller 24 and off-board system 20. Communication module 18 may include hardware and/or software (e.g., a multiplexer/demultiplexer, a transceiver, a signal modulator, an amplifier, an antennae 18a, etc.) that enables communication module 18 to send and/or receive data messages through a direct data link 26 or a wireless communication link 28. The wireless communications may include satellite, cellular, infrared, radio (RF), or another suitable band of electromagnetic radiation that enables controller 24 to wirelessly exchange information with off-board system 20.

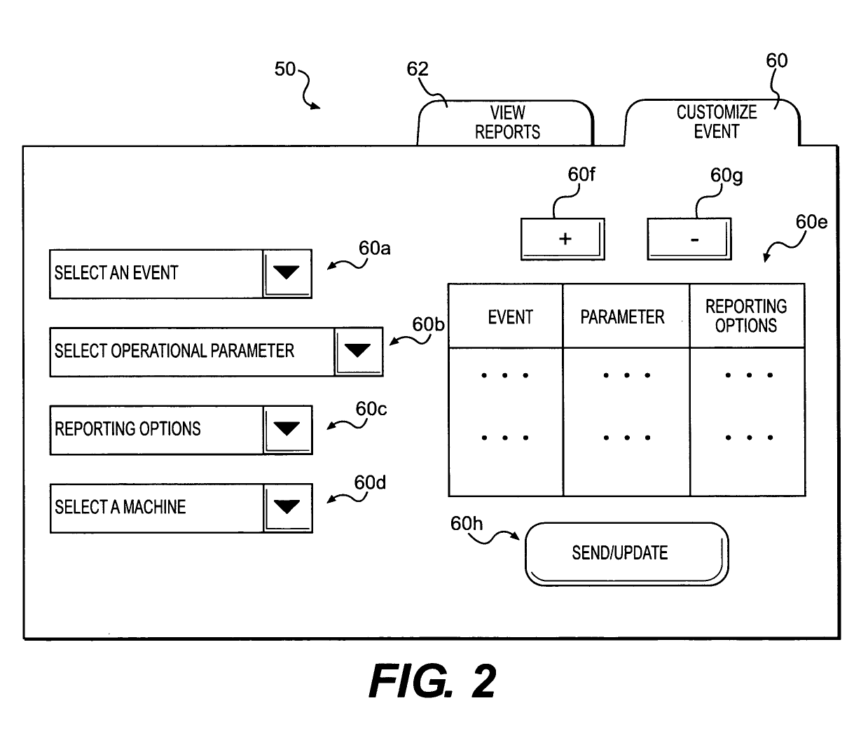

Off-board system 20 may represent one or more computing systems of a business entity associated with machine 10, such as a manufacturer, dealer, retailer, owner, or any other entity that generates, maintains, sends, and/or receives information associated with machine 10. The one or more computing systems may include a work station, a personal digital assistant, a laptop, a desktop, a mainframe, and/or other computing systems known in the art. Off-board system 20 may include any means for receiving machine operating parameter-related instructions from a user and/or for directly communicating with communication module 18 via data links 26, 28, such as, for example, a keyboard 20a, a mouse 20d, a monitor 20b, a touch-screen, a data port 20c, communications hardware and software, network interface and architecture, etc. The communications may include wireless telephone messages, pages, text-messages, electronic mail, packets, packet batches, or another desired communications packaging. Off-board system 20 may include suitable hardware, software, and/or firmware to run an application that implements event customization in accordance with the present disclosure, which will be discussed below in connection with FIG. 2. For example, off-board system 20 may include computer-readable storage components, such as, for example, read-only memories (ROM), random-access memories (RAM), and/or flash memory; secondary storage device(s), such as a tape-drive, an optical disk drive, and/or a magnetic disk drive; microprocessor(s) (CPU); and/or other components for running an application.

Operator interface 22 may include a monitor, a touch-screen, a portable hand-held device, a keypad, or another suitable interface. Interface 22 may receive input from a machine operator and generate corresponding command signals in response to the input. Interface 22 may also display data corresponding to machine status and/or performance in response to signals from controller 24.

Controller 24 may embody, for example, an electronic control module (ECM), a telematics control module, and/or another similar processing device. Controller 24 may include means for receiving machine operational parameter-related instructions from off-board system 20 and for monitoring, recording, storing, indexing, processing, and/or communicating machine operating parameters to off-board system 20. These means may include components such as, for example, a memory, one or more data storage devices, microprocessor(s), or any other components that may be used to run an application. Controller 24 may receive operational data and/or input commands directly from a machine operator during operation of machine 10 by way of interface 22.

Controller 24 may be in communication with the various components and subsystems of machine 10 via identification module 14, interface module 16, communication module 18, and operator interface 22 by way of communication links 30, 32, 34, and 36, respectively. Furthermore, although aspects of the present disclosure may be described generally as being stored in memory, one skilled in the art will appreciate that these aspects can be stored on or read from types of computer program products or computer-readable media, such as computer chips and secondary storage devices, including hard disks, floppy disks, optical media, CD-ROM, or other forms of RAM or ROM. Various other known circuits may be associated with controller 24 such as, for example, power supply circuitry, signal-conditioning circuitry, solenoid driver circuitry, timing circuitry, communication circuitry, and other suitable circuitry.

Controller 24 may include one or more tables, arrays, matrices, or other suitable data storage structures in memory to facilitate event detection and reporting. For example, controller 24 may include a table having a first dimension (e.g., rows) indexed by event and a second dimension (e.g., columns) indexed by operational parameter. The cells of the table may be appropriately marked and/or flagged as to indicate the operational parameter(s) to be monitored for each respective event. The cells may also include a predetermined value for the operational parameter that may trigger the occurrence of an event. Further, the table may suitably indicate which operational parameters should be returned, reported, and/or stored in memory when an event is triggered.

Certain events of interest that may be included in the table(s) and detected by controller 24 during operation include, for example, brake overheat, payload overload, payload under-load, engine stall, poor road condition, exhaust overheating, exhaust contamination, fuel inefficiency, etc. It is to be appreciated any suitable combination of the measured operational parameters discussed above may be used to detect and/or report the occurrence of the events. For example, individual brake temperatures may be monitored to detect a brake overheat event. When a brake overheat event occurs (i.e., when a measured temperature of the monitored brake(s) exceeds a threshold temperature previously set by the a user and/or machine operator), various parameters, which have been previously selected by the user and/or machine operator may be returned, including, for example, GPS location, groundspeed, stopping distance, brake temperatures, payload weight, and/or an operator identification number. Any desired number and combination of operational parameters be selected to trigger an event and selected for reporting in response to a triggered event.

During machine operation, controller 24 may, among other things, continually or periodically monitor, sample, and/or otherwise track the signals provided by sensors 16a-d. Controller 24 may access the table(s) mentioned above and compare the sampled operational parameter values to the target operational parameter values selected by the user or operator for each event listed in the table. It is contemplated that some triggers and/or reported parameters may be set to default values, if desired. When controller 24 determines an event has been triggered based on the comparison, controller 24 may report the event. That is, controller 24 may determine which operational parameters have been selected by the user or operator for reporting in association with the triggered event by referencing the table, and determine values for each of the operational parameters associated with the event based on the signals provided by sensors 16a-d. Controller 24 may then store in memory a report of the event, including the values of each of the operational parameters (e.g., a machine operation log). For example, the report may include one or more events in the form e(p1, p2, p3, . . . pn), wherein e is the event and p1-pn are each values of the respective parameters returned for the event. Alternatively or additionally, controller 24 may communicate the event, by way of communication module 18, to off-board system 20 for storage or logging in memory thereof. In another aspect, controller 24 may provide an alert to the operator by way of the operator interface, depending on the nature of the event and previous selections made by the user and/or operator.

The communication links referred to herein may include any suitable combination of wired and/or wireless non-proprietary links and/or proprietary links known in the art. Further, the communications may be executed according to any protocols based on known industry standards, such as, for example, SAE J1587, SAE J1939, RS-232, RP1210, RS-422, RS-485, MODBUS, SAEJ1587, Bluetooth, 802.11b or g, or any other suitable protocol known in the art. Further, the communications may be facilitated by wired and/or wireless network architecture, such as, for example, a cellular telephone-based network (such as a PBX or POTS), a satellite-based network, a local area network (LAN), a wide area network (WAN), a controller area network (CAN), a dedicated intranet, the Internet, and/or any other suitable network architecture known in the art.

FIG. 2 shows an exemplary graphical user interface (GUI) 50 useful for implementing event customization in accordance with this disclosure. It is to be appreciated that GUI 50 may be executed and provided to a user by way of off-board system 20 and/or to a machine operator by way of user interface 22. For example, GUI 50 may be a software tool allowing a user to manage the data acquisition systems of one or more machines (e.g., a fleet). GUI 50 may facilitate transmission, reception, and/or retrieval of data, such as event reports, operational parameters, settings, and/or other information to and from controller 24, and/or the controllers of other machines (not shown). GUI 50 may include menus (e.g., drop-down menus), modules, buttons, toolbars, and other means to facilitate the transfer of information between off-board system 20 and/or interface 22, and controller 24 and/or other machine controllers. It is to be appreciated that GUI 50 may require user authentication, such as, for example, a usemame, a password, a pin number, an electromagnetic passkey, etc., which may be entered by way of off-board system 20 and/or interface 22.

In one embodiment, GUI 50 may include an event customization feature 60. Feature 60 may provide one or more options 60a-h to facilitate customization of events to be monitored for triggering an event and/or reported by machine 10 upon triggering of the selected event. For example, feature 60 may include a menu 60a allowing a user to select an event (e.g., payload overload). Feature 60 may also include a menu 60b allowing the user to select one or more operational parameters to be monitored and/or reported (e.g., payload weight) for the selected event. For instance, menu 60b may define a list of available operational parameters stored in the memory of controller 24 and/or off-board system 20 that may be monitored by machine 10 during operation. It is to be appreciated that each event provided in menu 60a may also include one or more default operational parameters that may be monitored and/or reported in addition to the operation parameters selected from menu 60b by the user. In some cases, however, the user may be free to completely customize an event by selecting all operational parameters to be monitored and/or reported. It is contemplated that any desired combination of default and selected operational parameters may be monitored and/or reported for each event, if desired.

Feature 60 may also include a menu 60c allowing the user to set reporting options for each event and/or operational parameter. For example, the user may select threshold values (e.g., a certain temperature) at which events may be triggered, a sensitivity (e.g., low, medium, high) of the particular parameter and/or event, the manner in which the machine operator is alerted (e.g., display or audio), a communication mode defining the frequency at which triggered events may be reported or stored (e.g., continuously, hourly, daily, weekly, etc.), or any other desired reporting options.

Feature 60 may also include a menu 60d allowing the user to select a specific machine (e.g., machine “X” owned by “Y”) on which to customize events. Additionally, feature 60 may include a list 60e of events and respective operational parameters. In one aspect, list 60e may automatically display the particular event configuration for the machine selected in menu 60d by the user. That is, list 60e may display each event and its respective operational parameters for the particular selected machine. Further, feature 60 may include buttons 60f and 60g, to add or remove events from list 60e, respectively. For example, the user may highlight or otherwise select an event from list 60e and press button 60g to remove the event from list 60e. Likewise, the user may configure a desired event by selecting the event from menu 60a, selecting desired operational parameters from menu 60b, selecting desired reporting options from menu 60c, and pressing button 60f to add the event to the list. Further, feature 60 may include a button 60h to send, transmit, or otherwise communicate the customized events to be monitored and/or reported in list 60e to controller 24 of machine 10. That is, the event configuration stored in the table(s) of controller 24 may be updated to reflect the event configuration of list 60e.

GUI 50 may also include other features, such as, for example, a feature 62 allowing the user to view event reports for a particular machine, fleet of machines, machine operator, group of machine operators, etc. Feature 60 may also include one or more diagnostic tools (e.g., statistical tool) allowing the user to trend, model, or otherwise analyze the performance of particular machines, machine systems or components, operators, etc., based on the reports. For example, feature 60 may allow the user to determine the probability of a “brake overheat” event on a particular machine carrying a certain load and driven by a particular operator.

The present disclosure may be implemented in a variety of data communication network environments using software, hardware, or a combination of hardware and software to provide the processing functions. Those skilled in the art will appreciate that all or part of systems and methods consistent with the present disclosure may be stored on or read from other computer-readable media. Furthermore, one skilled in the art will also realize that the processes illustrated in this description may be implemented in a variety of ways and include multiple other modules, programs, applications, scripts, processes, threads, or code sections that may all functionally interrelate with each other to accomplish the individual tasks described. For example, it is contemplated that these programs modules may be implemented using commercially available software tools, using custom object-oriented code written in the C++programming language, using applets written in the Java programming language, or may be implemented as with discrete electrical components and/or integrated circuits (ASIC) designed for this purpose

Implementation of the disclosure may be, to some extent, undertaken manually. For example, designated persons, such as administrators, engineers, maintenance technicians, owners and/or retailers with the authority to use off-board system 20 and/or machine 10 may determine the pool of available operational parameters and/or events to be monitored and recorded. It is contemplated, however, that either a manual, semi-computerized, or fully computerized implementation may be utilized.

### INDUSTRIAL APPLICABILITY

The disclosed data acquisition system may be applicable to any machine where it is advantageous to customize the capture of events for diagnostic purposes. Specifically, capturing the occurrence of events based on user-selectable operational parameters may allow for efficient deployment of personnel and equipment resources; identification of problematic machine, operator, and/or environmental conditions; analysis of machine usage; and/or detection of other desired trends. The operation of data acquisition system 12 will now be described in detail.

In one aspect, an authorized user of off-board system 20 or an authorized machine operator (hereinafter “user”) may log in or otherwise access GUI 50. As indicated above, this may involve entering a usemame, password and/or appropriate key by way of off-board system 20 and/or interface 22, for example. The user may then access event customizing feature 60. Once event customizing feature 60 has been properly accessed, the user may select machine 10 (e.g., machine “X”, owned by “Y”) from menu 60d. In response, event configuration data may be received and/or retrieved from controller 24 of that particular machine and list 60e may be populated with the corresponding event configuration (e.g., as indicated by the table(s) stored in the memory of controller 24).

Subsequently, the user may select a desired event to customize by way of menu 60a. For example, the user may select the “brake overheat” event from menu 60a. The user may then add the brake overheat to list 60e by pressing or otherwise selecting button 60f. Based on personal experience, test data, machine specifications, and/or other available knowledge, the user may know that brake wear increases dramatically when brake temperature exceeds 200° C. Thus, the user may select this value as a trigger for the brake overheat event by way of menus 60b and/or 60c. Further, the user may be aware of certain operational parameters that may be useful in reporting, diagnosing, or otherwise analyzing a brake overheat event. For instance, the individual temperature of each brake, or components thereof, and their relationship to each other may indicate whether the machine's brakes are functioning properly. Likewise, ground speed, stopping distance, engine RPM, machine acceleration, transmission ratio, and/or operator identity may be used to determine if a specific operator's driving habits contribute to a brake overheat event. Further, a GPS location at the time of a brake overheat event may indicate if the terrain at a specific location of a worksite is problematic (e.g., too steep). As such, the user may wish to have values for any number of these operational parameters, and/or other such parameters, reported upon the occurrence of a brake overheat event. Therefore, the user may add the desired parameters for the brake overheat event to list 60e by selecting the desired parameters from menu 60b and pressing button 60f. It is to be appreciated that the user may tailor the reporting options for each event and/or operational parameter by way of menu 60c, if desired.

Upon completion of operational parameter selection, the user may similarly add and customize additional events, if desired. Once all desired events have been customized, added, and/or removed, the user may update the event configuration on controller 24 by pressing button 60h; that is, communicate the event configuration in list 60e to controller 24. Once the events have been received, controller 24 may, for example, update the table(s) mentioned above as to appropriately indicate the operational parameters to be monitored and/or recorded during operation.

During subsequent machine operation, controller 24 may continually or periodically sample, monitor, or otherwise track the signals provided by sensors 16a-d as to detect the occurrence of each of the events stored in the tables. That is, controller 24 may monitor and determine the values of the operational conditions of machine 10 based on the signals provided by sensors 16a-d, and compare the monitored values to the stored values for operational parameters associated with each event in the tables. In one scenario, for example, machine 10 may be traveling at a relatively high speed down a steep incline. In bringing the machine to a complete stop on the incline, the operator may engage the machine's brakes. Based on a temperature signal from one or more of the brakes exceeding the temperature trigger value selected by the user or operator and stored in the table(s) of controller 24, controller 24 may determine that a brake overheat event has been triggered.

Upon triggering of the brake overheat event, controller 24 may determine which operational parameters are associated with the event by referencing the table(s), as discussed above (i.e., have been previously selected by the user or operator). Controller 24 may then determine values for each of the operational parameters based on the tracked signals provided by sensors 16a-d, and return the values for each of the operational parameters. For example, controller 24 may return values for the individual temperatures of each of the brakes, an average machine ground speed, a GPS location, an inclination of machine 10, a transmission ratio (i.e., gear), engine RPM, stopping distance, the operator's identity, a time stamp, and/or other appropriate parameters associated with the occurrence of the “brake overheat” event. Controller 24 may then index and/or report the event, including values for each of the operational parameters (e.g., e(p1, p2, p3, . . . pn)), into a machine log or report stored in the memory of controller 24. Alternatively or additionally, the event may communicated to off-board system 20 for reporting and/or storage in memory in accordance with reporting options previously set in menu 60c, for example.

By employing the disclosed data acquisition system 12 and GUI 50 discussed above, a user may customize the manner in which machine operational events are triggered and reported to enhance the diagnostic value of the event reports. Particularly, the parameters, and values thereof, that trigger the events may be selected by a user. Further, the parameters that are returned and/or reported upon the triggering of a particular event may be selected by the user. In this manner, the user may tailor the event to facilitate the identification of trends in machine and/or operator usage, performance, and efficiency; environmental conditions; personnel and/or equipment deployment; and/or other desired variables.

It will be apparent to those skilled in the art that various modifications and variations can be made to the disclosed data acquisition system without departing from the scope of the invention. Other embodiments will be apparent to those skilled in the art from consideration of the specification. It is intended that the specification and examples be considered as exemplary only, with a true scope of the invention being indicated by the following claims and their equivalents.

What is claimed is:

1. A machine data acquisition system, comprising:
at least one sensor disposed on a machine and configured to produce a signal indicative of a value of an operational condition of the machine; and
a controller communicatively coupled to the at least one sensor, the controller being configured to:
receive a user-defined event associated with operation of the machine;
receive a user-defined trigger corresponding to the event;
receive a user-defined parameter to be reported upon triggering of the event; and
report an occurrence of the event and a value of the user-defined parameter based on the signal.

2. The data acquisition system of claim 1, further including an off-board system in communication with the controller to receive input from a user, wherein the user-defined parameter is selectable from a list of available monitored operational parameters via the off-board system.

3. The data acquisition system of claim 2, wherein the user-defined parameter is communicated to the controller in response to the input.

4. The data acquisition system of claim 2, wherein reporting the event includes communicating the event and the value of the user-defined parameter to the off-board system for storage.

5. The data acquisition system of claim 2, wherein the controller is configured to wirelessly communicate with the off-board system.

6. The data acquisition system of claim 1, further including an operator interface on the machine communicatively coupled to the controller and being configured to receive input from a machine operator, wherein the user-defined parameter is selectable from a list of available monitored operational parameters in response to the input.

7. The data acquisition system of claim 1, wherein the user-defined trigger includes a predetermined value of an operational condition of the machine.

8. The data acquisition system of claim 1, wherein the controller is further configured to report at least one default parameter corresponding to the event.

9. A method of acquiring machine data, comprising:
sensing a value of at least one operational condition of the machine;
receiving a user-defined event associated with operation of the machine;
receiving a user-defined trigger corresponding to the event;
receiving a user-defined parameter to be reported upon triggering of the event; and
reporting an occurrence of the event and a value for the user-defined parameter based on the signal.

10. The method of claim 9, wherein receiving a user-defined parameter includes receiving from an operator of the machine a selection of the user-defined parameter from a plurality of available monitored parameters.

11. The method of claim 9, wherein receiving a user-defined parameter includes receiving from a user of an off-board system a selection of the user-selected parameter from a plurality of available monitored parameters.

12. The method of claim 9, wherein reporting the event includes communicating the event and the value of the user-defined parameter to an off-board system for storage.

13. The method of claim 9, further including reporting a value of at least one default parameter associated with the event.

14. A machine, comprising:
a power source configured to power operations of the machine;
a traction device coupled to the power source to propel the machine;
a tool; and
a data acquisition system disposed on the machine, including:
at least one sensor disposed on a machine and configured to produce a signal indicative of a value of an operational condition of the machine; and
a controller communicatively coupled to the at least one sensor, the controller being configured to:
receive a user-defined event associated with operation of the machine;
receive a user-defined trigger corresponding to the event;
receive a user-defined parameter to be reported upon triggering of the event; and
report an occurrence of the event and a value of the user-defined parameter based on the signal.

15. The machine of claim 14, further including an off-board system in communication with the controller to receive input from a user, wherein the user-defined parameter is selectable from a list of available monitored operational parameters via the off-board system.

16. The machine of claim 15, wherein the user-defined parameter is communicated to the controller in response to the input.

17. The machine of claim 15, wherein reporting the event includes communicating the event and the value of the user-defined parameter to the off-board system for storage.

18. The machine of claim 15, wherein the controller is configured to wirelessly communicate with the off-board system.

19. The machine of claim 14, further including an operator interface on the machine communicatively coupled to the controller and being configured to receive input from a machine operator, wherein the user-defined parameter is selectable from a list of available monitored operational parameters in response to the input.

20. The machine of claim 14, wherein the controller is further configured to report at least one default parameter corresponding to the event.
